(19) United States
(12) Patent Application Publication
(10) Pub. No.: US 2025/0274224 A1
(43) Pub. Date: Aug. 28, 2025

(54) DEADLINE BASED HYBRID AUTOMATIC REPEAT REQUEST RETRANSMISSION

(71) Applicant: QUALCOMM INCORPORATED, San Diego, CA (US)

(72) Inventors: Linhai He, San Diego, CA (US); Gavin Bernard Horn, La Jolla, CA (US); Ruiming Zheng, Beijing (CN); Yuchul Kim, San Diego, CA (US); Huilin Xu, Temecula, CA (US)

(21) Appl. No.: 18/859,127

(22) PCT Filed: Jun. 22, 2022
(86) PCT No.: PCT/CN2022/100363

§ 371 Date: Oct. 22, 2024

(51) Int. Cl. H04L 1/1812; H04W 72/1268; H04W 72/20; H04W 76/28

(52) U.S. Cl. CPC H04L 1/1812; H04W 72/1268; H04W 72/20; H04W 76/28

(57) ABSTRACT

Methods, systems, and devices for wireless communications are described. A user equipment (UE) may receive control signaling identifying a packet delay budget for a logical channel for a UE. The UE may transmit one or more instances of an uplink message associated with the same hybrid automatic repeat request (HARQ) process identification, where the transmission of the first instance of the one or more instances of the uplink message is associated with the start of the packet delay budget for the logical channel. The one or more instances may be associated with a retransmission procedure for the uplink message. The UE may end the retransmission procedure associated with the uplink message based on the elapsed buffering time of the uplink message exceeding the packet delay budget.

### CROSS REFERENCE

The present application is a 371 national stage filing of International PCT Application No. PCT/CN2022/100363 by He et al. entitled “DEADLINE BASED HYBRID AUTOMATIC REPEAT REQUEST RETRANSMISSION,” filed Jun. 22, 2022, which is assigned to the assignee hereof, and which is expressly incorporated by reference in its entirety herein.

### TECHNICAL FIELD

The following relates to wireless communications, including deadline based hybrid automatic repeat request retransmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support deadline based hybrid automatic repeat request (HARQ) retransmission. For example, the described techniques provide for configuration of a packet delay budget for a logical channel for a user equipment (UE). A UE may receive control signaling identifying a packet delay budget for a logical channel for a UE. The packet delay budget may start based on the generation of data for or transmission of an uplink transmission scheduled by a first uplink grant for the logical channel. For example, the UE may transmit one or more instances of an uplink message associated with the same feedback process (e.g., HARQ) identification, where the transmission of the first instance of the one or more instances of the uplink message is associated with the start of the packet delay budget for the logical channel. The one or more instances may be associated with a retransmission procedure for the uplink message. After the configured packet delay budget (e.g., after an elapsed buffering time for the uplink message exceeds the packet delay budget), the UE may skip transmission of at least one instance of the one or more instances of the uplink message associated with the same HARQ process identification for the logical channel that is scheduled for transmission after the packet delay budget. For example, the UE may end the retransmission procedure associated with the uplink message based on the elapsed buffering time of the uplink message exceeding the packet delay budget.

A method for wireless communications at a user equipment (UE) is described. The method may include receiving control signaling that identifies a packet delay budget for wireless communications over a logical channel, transmitting, using the logical channel, one or more instances of an uplink message that are each associated with a same hybrid automatic repeat request (HARQ) process identification, transmission of a first of the one or more instances of the uplink message being associated with a start of the packet delay budget for the logical channel, the one or more instances of the uplink message being associated with a retransmission procedure for the uplink message, and ending the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

An apparatus for wireless communications at a UE is described. The apparatus may at least one processor and memory coupled to the at least one processor, the memory storing instructions. The instructions may be executable by the processor to cause the UE to receive control signaling that identifies a packet delay budget for wireless communications over a logical channel, transmit, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message, and end the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

Another apparatus for wireless communications at a UE is described. The apparatus may include means for receiving control signaling that identifies a packet delay budget for wireless communications over a logical channel, means for transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message, and means for ending the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

A non-transitory computer-readable medium storing code for wireless communications at a UE is described. The code may include instructions executable by at least one processor to receive control signaling that identifies a packet delay budget for wireless communications over a logical channel, transmit, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message, and end the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

Some examples of the method, apparatuses, and non-transitory computer-readable medium described herein may further include operations, features, means, or instructions for receiving one or more uplink grants that each schedule a corresponding transmission of the one or more instances of the uplink message, where ending the retransmission procedure further includes skipping one of the one or more uplink grants.

Some examples of the method, apparatuses, and non-transitory computer-readable medium described herein may further include operations, features, means, or instructions for starting a discontinuous reception retransmission timer based on receiving one of the one or more uplink grants and stopping the discontinuous reception retransmission timer based on the elapsed buffering time of the uplink message exceeding the packet delay budget.

Some examples of the method, apparatuses, and non-transitory computer-readable medium described herein may further include operations, features, means, or instructions for receiving second control signaling that may be indicative of a configured grant configuration for the UE, where the one or more instances of the uplink message may be transmitted in accordance with the configured grant configuration.

Some examples of the method, apparatuses, and non-transitory computer-readable medium described herein may further include operations, features, means, or instructions for starting a configured grant timer based on transmission of the first of the one or more instances of the uplink message and stopping the configured grant timer based on the elapsed buffering time of the uplink message exceeding the packet delay budget.

Some examples of the method, apparatuses, and non-transitory computer-readable medium described herein may further include operations, features, means, or instructions for skipping transmission of an additional instance of the one or more instances of the uplink message based on the configured grant timer being stopped.

In some examples of the method, apparatuses, and non-transitory computer-readable medium described herein, receiving the control signaling that identifies the packet delay budget may include operations, features, means, or instructions for receiving a set of multiple packet delay budgets each associated with a respective logical channel of a set of multiple logical channels, where the packet delay budget that may be used to determine whether to end the retransmission procedure may be a smallest packet delay budget of the set of multiple packet delay budgets associated with the set of multiple logical channels associated with transmission of a same transport block.

Some examples of the method, apparatuses, and non-transitory computer-readable medium described herein may further include operations, features, means, or instructions for receiving an uplink grant that schedules an application data unit, where the one or more instances of the uplink message include a set of multiple packets configured to be decoded synchronously as the application data unit, and where ending the retransmission procedure further includes skipping transmission of a portion of the set of multiple packets of the application data unit.

### BRIEF DESCRIPTION OF THE DRAWINGS

FIG. 1 illustrates an example of a wireless communications system that supports deadline based hybrid automatic repeat request retransmission in accordance with one or more aspects of the present disclosure.

FIG. 2 illustrates an example of a wireless communications system that supports deadline based hybrid automatic repeat request retransmission in accordance with one or more aspects of the present disclosure.

FIG. 3 illustrates an example of a timing diagram that supports deadline based hybrid automatic repeat request retransmission in accordance with one or more aspects of the present disclosure.

FIG. 4 illustrates an example of a process flow that supports deadline based hybrid automatic repeat request retransmission in accordance with one or more aspects of the present disclosure.

FIGS. 5 and 6 show block diagrams of devices that support deadline based hybrid automatic repeat request retransmission in accordance with one or more aspects of the present disclosure.

FIG. 7 shows a block diagram of a communications manager that supports deadline based hybrid automatic repeat request retransmission in accordance with one or more aspects of the present disclosure.

FIG. 8 shows a diagram of a system including a device that supports deadline based hybrid automatic repeat request retransmission in accordance with one or more aspects of the present disclosure.

FIGS. 9 through 12 show flowcharts illustrating methods that support deadline based hybrid automatic repeat request retransmission in accordance with one or more aspects of the present disclosure.

### DETAILED DESCRIPTION

In some wireless communications systems, some applications may demand high reliability and low latency transmissions. For example, extended reality (XR) traffic, may demand high reliability and low latency transmissions. For example, a network entity may transmit video frames to an XR user (e.g., a user equipment (UE)) or a UE may transmit video frames to a network entity. A defined (e.g., minimum) amount of data an application software may process at a time (e.g., the granularity of data processed by an application software) may be referred to as an application data unit (ADU). Because of the strict latency demands associated with ADUs, some packets may become obsolete to an application if the packets are not received within a packet delay budget (e.g., are not received within a duration to be processed with the other packets of the same ADU).

An end-to-end packet delay budget may be defined between a UE and an application server. The end-to-end packet delay budget may provide a packet delay budget guideline, but may be impractical to apply for a UE for layer 2 procedures for uplink transmissions. For layer 2 procedures, for downlink transmissions, the UE may be unaware of the routing delay through the core network and the scheduling delay at the serving base station for each individual packet. For layer 2 procedures, for uplink transmissions, the network (e.g., a serving network entity) may be unaware of the delay of each packet before the packet is transmitted on a physical uplink shared channel (PUSCH) or a physical uplink control channel (PUCCH). Accordingly, the network may transmit uplink grants for transmissions of packets or retransmissions of packets (e.g., based on hybrid automatic repeat request (HARQ) feedback) even when the transmission of the packet or retransmission of the packet would be obsolete (e.g., because the transmission or retransmission would be outside of the packet delay budget associated with the ADU for the packet). Monitoring for uplink grants for obsolete packets and transmitting obsolete packets may waste resources at the UE.

The network may configure a packet delay budget for a logical channel or data radio bearer for a UE, and the UE may monitor for uplink grants for the logical channel or data radio bearer based on the configured packet delay budget. For uplink, the configured packet delay budget may be based on a maximum delay from a time when data is generated by an application at the UE to the time when a transport block including the data is received at a medium access control layer at the network. Accordingly, the packet delay budget may be based on a deadline for a HARQ process for the UE. For example, the packet delay budget may start based on the generation of data for or transmission of an uplink transmission scheduled by a first uplink grant for the logical channel. For example, the UE may transmit one or more instances of an uplink message associated with the same HARQ process identification, where the transmission of the first instance of the one or more instances of the uplink message is associated with the start of the packet delay budget for the logical channel. The one or more instances may be associated with a retransmission procedure for the uplink message. After a duration based on the configured packet delay budget (e.g., after an elapsed buffering time for the uplink message exceeds the packet delay budget), the UE may skip transmission of at least one instance of the one or more instances of the uplink message associated with the same HARQ process identification for the logical channel that is scheduled for transmission after the packet delay budget. For example, the UE may end the retransmission procedure associated with the uplink message based on the elapsed buffering time of the uplink message exceeding the packet delay budget.

In some cases, the UE may receive an uplink grant scheduling an ADU, where the one or more instances of the uplink message may include a number of packets configured to be decoded synchronously as the ADU. Ending the retransmission procedure may include skipping a portion of the number of packets of the ADU.

The UE may monitor for additional uplink grants associated with the same HARQ process identifier or associated with the same configured grant as the first uplink grant for a duration based on the configured packet delay budget for the logical channel. After a duration based on the configured packet delay budget (e.g., after the elapsed buffering time for the uplink message exceeds the packet delay budget) the UE may skip uplink grants for the logical channel. In some cases, the UE may skip all uplink grants associated with transport blocks associated with the same ADU (e.g., across logical channels associated with the same ADU) based on exceeding a packet delay budget for any logical channel associated with the same ADU.

Aspects of the disclosure are initially described in the context of wireless communications systems. Aspects of the disclosure are further illustrated by and described with reference to timing diagrams and process flows. Aspects of the disclosure are further illustrated by and described with reference to apparatus diagrams, system diagrams, and flowcharts that relate to deadline based hybrid automatic repeat request retransmission.

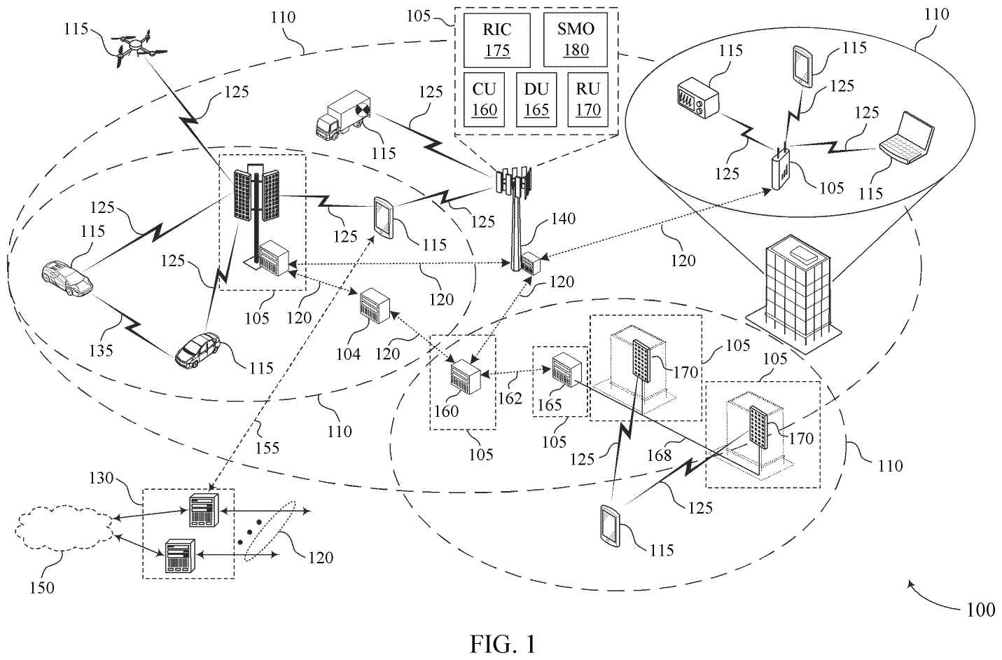

FIG. 1 illustrates an example of a wireless communications system 100 that supports deadline based hybrid automatic repeat request retransmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support deadline based hybrid automatic repeat request retransmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. HARQ feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, the some application supported by the wireless communications system 100 may demand high reliability and low latency transmissions. For example, the wireless communications system 100 may support XR traffic, which may demand high reliability and low latency transmissions. For example, a network entity 105 may transmit video frames to an XR user (e.g., a UE 115) or a UE 115 may transmit video frames to a network entity 105.

The network may configure a packet delay budget for a logical channel for a UE 115, and the UE 115 may monitor for uplink grants for the logical channel based on the configured packet delay budget. For example, a network entity 105 may transmit control signaling to the UE 115 that identifies a packet delay budget for a logical channel. The packet delay budget may start based on the generation of data for (e.g., based on the start of buffering data for the uplink transmission) or transmission of an uplink transmission scheduled by a first uplink grant for the logical channel. For example, the UE 115 may transmit one or more instances of an uplink message associated with the same feedback process (e.g., HARQ) identification, where the transmission of the first instance of the one or more instances of the uplink message is associated with the start of the packet delay budget for the logical channel. The one or more instances may be associated with a retransmission procedure for the uplink message. After a duration based on the configured packet delay budget (e.g., after an elapsed buffering time for the uplink message exceeds the packet delay budget), the UE 115 may skip transmission of at least one instance of the one or more instances of the uplink message associated with the same HARQ process identification for the logical channel that is scheduled for transmission after the packet delay budget. For example, the UE 115 may end the retransmission procedure associated with the uplink message based on the remaining portion of the packet delay budget is less than a threshold amount of time.

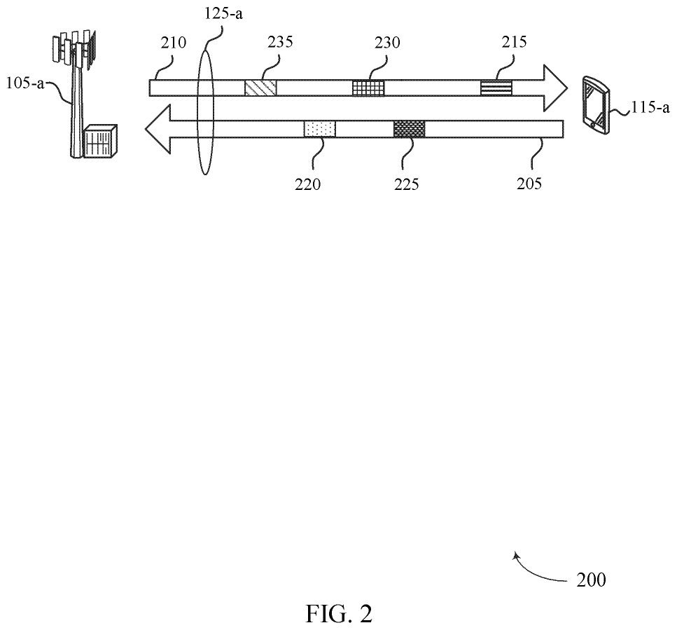

FIG. 2 illustrates an example of a wireless communications system 200 that supports deadline based hybrid automatic repeat request retransmission in accordance with one or more aspects of the present disclosure. In some examples, the wireless communications system 200 may implement aspects of wireless communications system 100. The wireless communications system 200 may include a UE 115-a, which may be an example of a UE 115 as described herein. The wireless communications system 200 may include a network entity 105-a, which may be an example of a network entity 105 as described herein.

The UE 115-a may communicate with the network entity 105-a using a communication link 125-a, which may be examples of NR or LTE links between the UE 115-a and the network entity 105-a. The communication link 125-a may include a bi-directional link that enables both uplink and downlink communication. For example, the UE 115-a may transmit uplink signals 205, such as uplink control signals or uplink data signals, to the network entity 105-a using the communication link 125-a and the network entity 105-a may transmit downlink signals 210, such as downlink control signals or downlink data signals, to the UE 115-a using the communication link 125-a.

The UE 115-a may receive, from the network entity 105-a, control signaling 215 that identifies a packet delay budget for wireless communications over a logical channel. In some cases, the control signaling may be received via an RRC message. In some cases, the control signaling 215 may configure the logical channel with a deadline for HARQ.

The UE 115-a may transmit a first instance 220 of an uplink message using the logical channel. The UE 115-a may start a packet delay budget associated with the first instance 220 of the uplink message. The UE 115-a may transmit one or more additional instances 225 of the uplink message. For example, the UE 115-a may perform a retransmission procedure for the uplink message. For example, the retransmission procedure may include transmitting the one or more additional instances 225 of the uplink message after the transmission of the first instance 220 based on feedback received from the network entity 105-a. For example, the UE 115-a may receive an uplink grant 230 that schedules the first instance 220 of the uplink message, and the UE 115-a may monitor for additional uplink grants 235 for retransmissions of the uplink message and transmit one or more additional instances 225 of the uplink message based on receiving additional uplink grants 235.

The UE 115-a may end the retransmission procedure based on determining that an elapsed buffering time of the uplink message exceeds the packet delay budget. For example, the UE 115-a may skip additional instances scheduled by additional uplink grants 235 for retransmissions of the uplink message based on determining that the elapsed buffering time of the uplink message exceeds the packet delay budget. In some cases, the UE 115-a may refrain from monitoring for additional uplink grants 235 for retransmissions of the uplink message based on determining that the elapsed buffering time of the uplink message exceeds the packet delay budget.

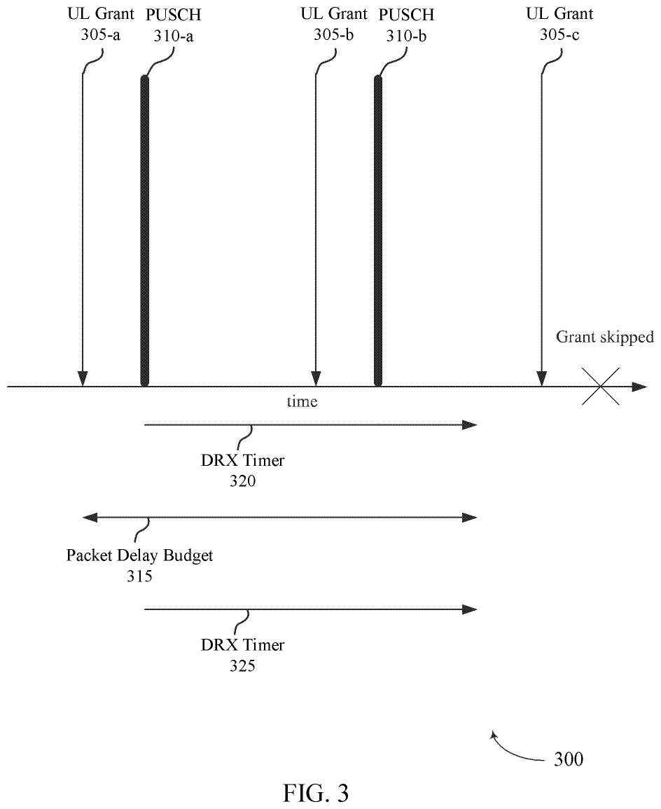

FIG. 3 illustrates an example of a timing diagram 300 that supports deadline based hybrid automatic repeat request retransmission in accordance with one or more aspects of the present disclosure. In some examples, the timing diagram 300 may implement aspects of wireless communications systems 100 or 200.

As described herein, a UE 115 may skip or drop a transport block on a logical channel or data radio bearer once the residual delay budget for the logical channel or data radio bearer is below a threshold level (e.g., after an elapsed buffering time for an uplink message associated with the transport block exceeds a packet delay budget for the logical channel or data radio bearer). With asynchronous HARQ feedback, a transport block may not be dropped unless the new data indicator field is toggled. To implement dropping of a transport block for a logical channel or data radio bearer, the UE 115 may implement uplink skipping.

In some cases, the UE 115 may receive control signaling (e.g., via RRC) with a deadline for HARQ (e.g., a packet delay budget 315). Based on receiving the control signaling with a deadline for HARQ, the UE 115 may perform deadline based uplink skipping based on the packet delay budget 315.

For example, a UE 115 may receive a first uplink grant 305-a that schedules a first uplink transmission 310-a for a logical channel. A configured packet delay budget 315 for the logical channel may start based on the generation of data for transmission in the first uplink transmission 310-a or based on the transmission of the first uplink transmission 310-a. The UE 115 may monitor for uplink grants for the logical channel while the residual packet delay budget (e.g., the remaining portion of the packet delay budget) for the logical channel is greater than a threshold amount of time. For example, the UE 115 may monitor for and receive the uplink grant 305-b while the residual packet delay budget for the logical channel is greater than the threshold amount of time, and the UE 115 may transmit the uplink transmission 310-b scheduled by the uplink grant 305-b. After the residual packet delay budget for the logical channel is less than the threshold amount of time (e.g., once the packet delay budget expires), the UE 115 may skip scheduled uplink transmissions associated with the same HARQ process identification. For example, the UE 115 may skip the uplink transmission scheduled by the uplink grant 305-c or may skip monitoring for the uplink grant 305-c and accordingly skip the uplink transmission scheduled by the uplink grant 305-c.

In some cases, a transport block may include multiple MAC service data units (SDUs) from logical channels associated with different respective deadlines (e.g., packet delay budgets). The deadline for a transport block that includes multiple MAC SDUs from logical channels associated with different respective packet delay budgets may be the smallest packet delay budget of the respective packet delay budgets.

In some cases, if a transport block in a HARQ buffer has passed a deadline associated with the transport block, the UE 115 may skip any subsequent uplink grant for that HARQ process. Such skipping may be applied to either new transmissions or retransmissions of dynamic uplink grants, addressed to either cell radio network temporary identifier (C-RNTI) or configured scheduling radio network temporary identifier (CS-RNTI). In some cases, skipping uplink grants may be applicable to autonomous retransmission over configured grants (e.g., where the uplink transmissions 310 are configured grant transmissions).

In some cases, the UE 115 may start a discontinuous reception (DRX) retransmission timer 320 associated with a HARQ process for an uplink transmission 310-a based on receiving the first uplink grant 305-a. The UE 115 may stop the DRX retransmission timer 320 based on the packet delay budget 315. The UE 115 may stop skip uplink grants associated with the HARQ process identification based on stopping the DRX retransmission timer 320.

In some cases, if the first uplink transmission 310-a of the transport block is over a configured grant, the UE 115 may stop a configured grant timer 325 associated with a HARQ process for the uplink transmission 310-a. The UE 115 may skip uplink grants associated with the HARQ process identification based on stopping the configured grant timer 325.

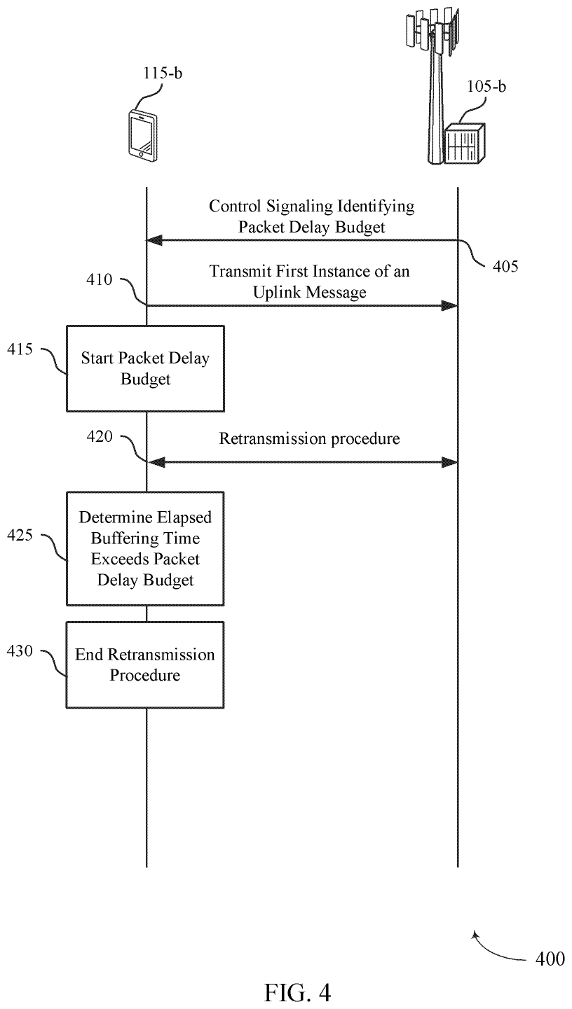

FIG. 4 illustrates an example of a process flow 400 that supports deadline based hybrid automatic repeat request retransmission in accordance with one or more aspects of the present disclosure. The process flow 400 may include a UE 115-b, which may be an example of a UE 115 as described herein. The process flow 400 may include a network entity 105-b, which may be an example of a network entity 105 as described herein. In the following description of the process flow 400, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 400, and other operations may be added to the process flow 400.

At 405, the UE 115-b may receive, from the network entity 105-b, control signaling that identifies a packet delay budget for wireless communications over a logical channel. In some cases, the control signaling may be received via an RRC message.

At 410, the UE 115-b may transmit a first instance of an uplink message using the logical channel.

At 415, the UE 115-b may start the packet delay budget, where the start of the packet delay budget is associated with the transmission of the first instance of the uplink message at 410.

At 420, the UE 115-b may perform a retransmission procedure for the uplink message. For example, the retransmission procedure may include transmitting instances of the uplink message after the transmission of the first instance at 410 based on feedback received from the network entity 105-b. For example, the UE 115-b may monitor for uplink grants for retransmissions of the uplink message and transmit instances of the uplink message based on receiving additional uplink grants.

At 425, the UE 115-b may determine that an elapsed buffering time of the uplink message exceeds the packet delay budget.

At 430, the UE 115-b may end the retransmission procedure based on determining that the elapsed buffering time of the uplink message exceeds the packet delay budget. Ending the retransmission procedure may include skipping transmission of at least one instance of the one or more instances of the uplink message scheduled for transmission after the packet delay budget.

In some cases, the UE 115-b may receive, from the network entity 105-b, one or more uplink grants that each schedule a corresponding transmission of the one or more instances of the uplink message, and ending the retransmission procedure includes skipping one of the one or more uplink grants. In some cases, the UE 115-b may start a DRX retransmission timer based on receiving one of the one or more uplink grants, and the UE 115-b may stop the DRX retransmission timer based on the elapsed buffering time of the uplink message exceeding the packet delay budget

In some cases, the UE 115-b may receive second control signaling that is indicative of a configured grant configuration for the UE 115-b, and the one or more instances of the uplink message are transmitted in accordance with the configured grant configuration. In some cases, the UE 115-b may start a configured grant timer based on transmission of the first of the one or more instances of the uplink message at 410, and the UE 115-b may stop the configured grant timer based on the elapsed buffering time of the uplink message exceeding the packet delay budget. In some cases, the UE 115-b may skip transmission of an additional instance of the one or more instances of the uplink message based on the configured grant timer being stopped.

In some cases, the UE 115-b may receive, with the control signaling at 405, a set of multiple packet delay budgets each associated with a respective logical channel of a set of multiple logical channels, where the packet delay budget that is used to determine whether to end the retransmission procedure is a smallest packet delay budget of the set of multiple packet delay budgets associated with the set of multiple logical channels associated with transmission of a same transport block.

In some cases, the UE 115-b may receive an uplink grant that schedules an ADU, where the one or more instances of the uplink message include a plurality of packets configured to be decoded synchronously as the ADU. Ending the retransmission procedure may include skipping transmission of a portion of the plurality of packets of the ADU.

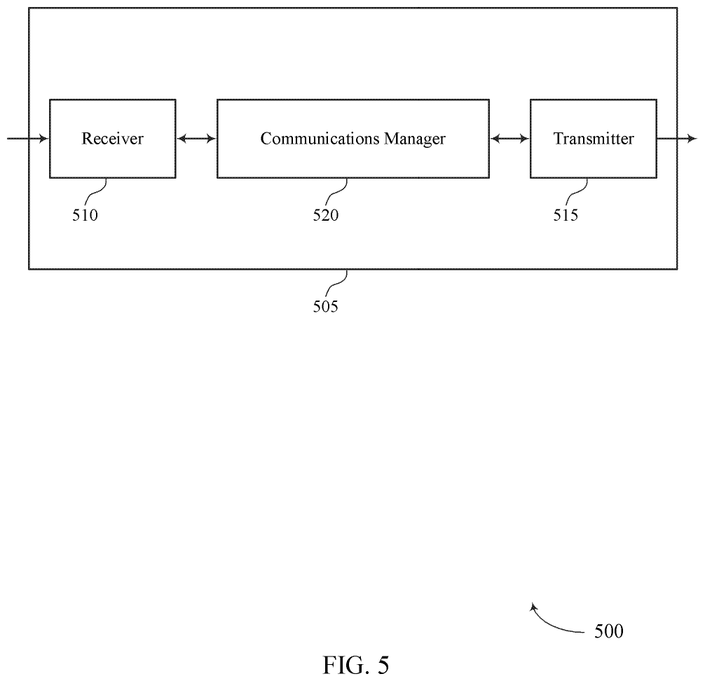

FIG. 5 shows a block diagram 500 of a device 505 that supports deadline based hybrid automatic repeat request retransmission in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to deadline based hybrid automatic repeat request retransmission). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to deadline based hybrid automatic repeat request retransmission). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of deadline based hybrid automatic repeat request retransmission as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software) executed by a processor. If implemented in code executed by a processor, the functions of the communications manager 520, the receiver 510, the transmitter 515, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving control signaling that identifies a packet delay budget for wireless communications over a logical channel. The communications manager 520 may be configured as or otherwise support a means for transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The communications manager 520 may be configured as or otherwise support a means for ending the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources by configuring and applying packet delay budgets.

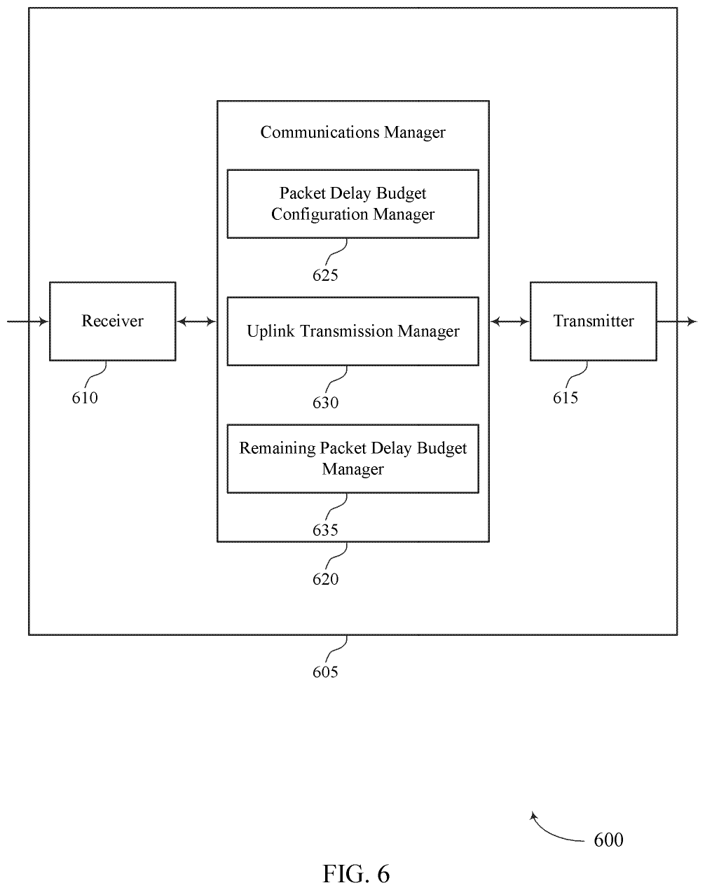

FIG. 6 shows a block diagram 600 of a device 605 that supports deadline based hybrid automatic repeat request retransmission in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to deadline based hybrid automatic repeat request retransmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to deadline based hybrid automatic repeat request retransmission). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of deadline based hybrid automatic repeat request retransmission as described herein. For example, the communications manager 620 may include a packet delay budget configuration manager 625, an uplink transmission manager 630, a remaining packet delay budget manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The packet delay budget configuration manager 625 may be configured as or otherwise support a means for receiving control signaling that identifies a packet delay budget for wireless communications over a logical channel. The uplink transmission manager 630 may be configured as or otherwise support a means for transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The remaining packet delay budget manager 635 may be configured as or otherwise support a means for ending the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

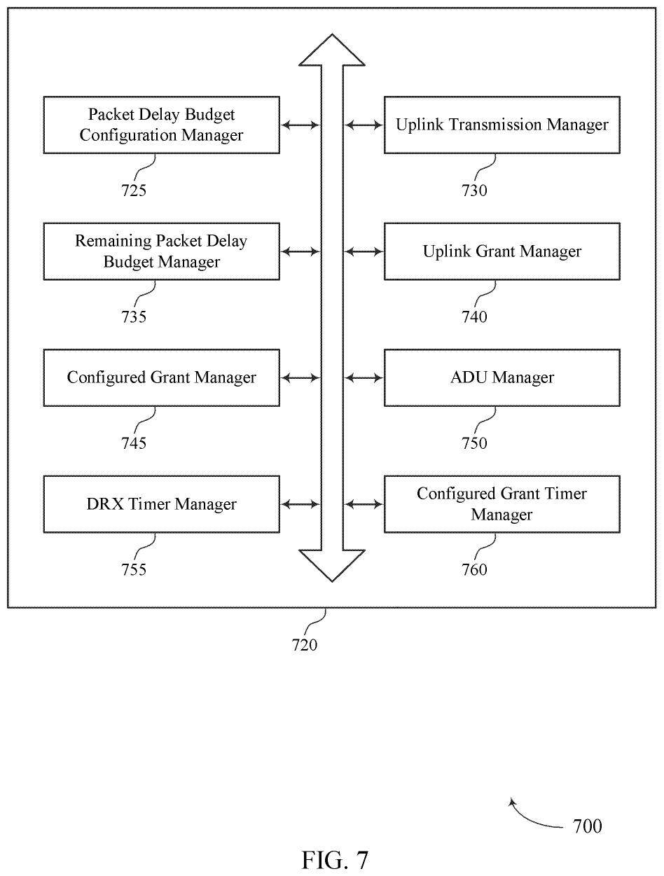

FIG. 7 shows a block diagram 700 of a communications manager 720 that supports deadline based hybrid automatic repeat request retransmission in accordance with one or more aspects of the present disclosure. The communications manager 720 may be an example of aspects of a communications manager 520, a communications manager 620, or both, as described herein. The communications manager 720, or various components thereof, may be an example of means for performing various aspects of deadline based hybrid automatic repeat request retransmission as described herein. For example, the communications manager 720 may include a packet delay budget configuration manager 725, an uplink transmission manager 730, a remaining packet delay budget manager 735, an uplink grant manager 740, a configured grant manager 745, an ADU manager 750, a DRX timer manager 755, a configured grant timer manager 760, or any combination thereof. Each of these components may communicate, directly or indirectly, with one another (e.g., via one or more buses).

The communications manager 720 may support wireless communications at a UE in accordance with examples as disclosed herein. The packet delay budget configuration manager 725 may be configured as or otherwise support a means for receiving control signaling that identifies a packet delay budget for wireless communications over a logical channel. The uplink transmission manager 730 may be configured as or otherwise support a means for transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The remaining packet delay budget manager 735 may be configured as or otherwise support a means for ending the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

In some examples, the uplink grant manager 740 may be configured as or otherwise support a means for receiving one or more uplink grants that each schedule a corresponding transmission of the one or more instances of the uplink message, where ending the retransmission procedure further includes skipping one of the one or more uplink grants.

In some examples, the DRX timer manager 755 may be configured as or otherwise support a means for starting a DRX retransmission timer based on receiving one of the one or more uplink grants. In some examples, the DRX timer manager 755 may be configured as or otherwise support a means for stopping the DRX retransmission timer based on the elapsed buffering time of the uplink message exceeding the packet delay budget.

In some examples, the configured grant manager 745 may be configured as or otherwise support a means for receiving second control signaling that is indicative of a configured grant configuration for the UE, where the one or more instances of the uplink message are transmitted in accordance with the configured grant configuration.

In some examples, the configured grant timer manager 760 may be configured as or otherwise support a means for starting a configured grant timer based on transmission of the first of the one or more instances of the uplink message. In some examples, the configured grant timer manager 760 may be configured as or otherwise support a means for stopping the configured grant timer based on the elapsed buffering time of the uplink message exceeding the packet delay budget.

In some examples, the uplink transmission manager 730 may be configured as or otherwise support a means for skipping transmission of an additional instance of the one or more instances of the uplink message based on the configured grant timer being stopped.

In some examples, to support receiving the control signaling that identifies the packet delay budget, the packet delay budget configuration manager 725 may be configured as or otherwise support a means for receiving a set of multiple packet delay budgets each associated with a respective logical channel of a set of multiple logical channels, where the packet delay budget that is used to determine whether to end the retransmission procedure is a smallest packet delay budget of the set of multiple packet delay budgets associated with the set of multiple logical channels associated with transmission of a same transport block.

In some examples, the ADU manager 750 may be configured as or otherwise support a means for receiving an uplink grant that schedules an ADU, where the one or more instances of the uplink message include a set of multiple packets configured to be decoded synchronously as the ADU, and where ending the retransmission procedure further includes skipping transmission of a portion of the set of multiple packets of the ADU.

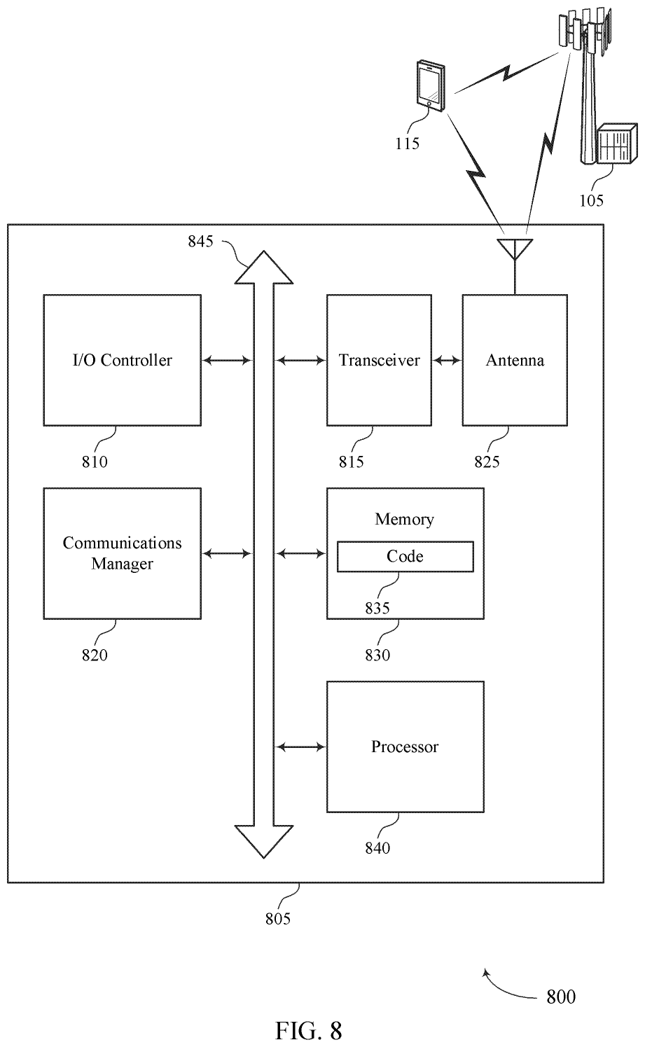

FIG. 8 shows a diagram of a system 800 including a device 805 that supports deadline based hybrid automatic repeat request retransmission in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, or electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting deadline based hybrid automatic repeat request retransmission). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving control signaling that identifies a packet delay budget for wireless communications over a logical channel. The communications manager 820 may be configured as or otherwise support a means for transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The communications manager 820 may be configured as or otherwise support a means for ending the retransmission procedure based on an elapsed buffering time of the uplink message exceeding the packet delay budget, where ending the retransmission procedure includes skipping transmission of at least one instance of the one or more instances of the uplink message scheduled for transmission after the packet delay budget.

By including or configuring the communications manager 820 in accordance with examples as described herein, the device 805 may support techniques for more efficient utilization of communication resources and improved utilization of processing capability by configuring and applying packet delay budgets.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of deadline based hybrid automatic repeat request retransmission as described herein, or the processor 840 and the memory 830 may be otherwise configured to perform or support such operations.

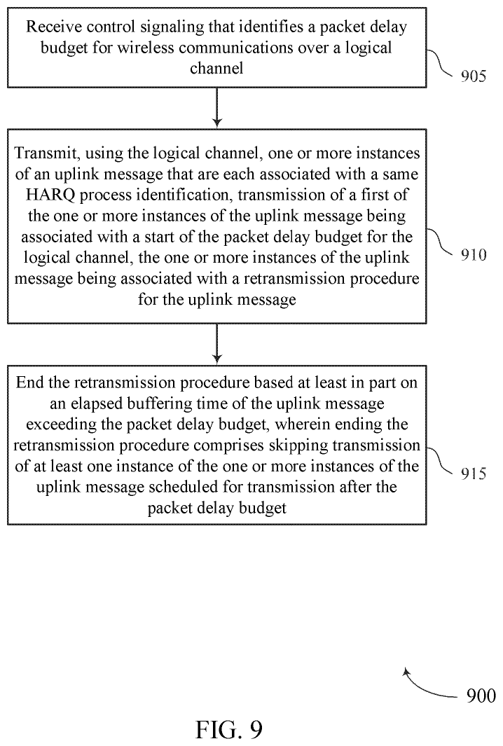

FIG. 9 shows a flowchart illustrating a method 900 that supports deadline based hybrid automatic repeat request retransmission in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving control signaling that identifies a packet delay budget for wireless communications over a logical channel. The operations of 905 may be performed in accordance with examples as disclosed herein. In some examples, aspects of the operations of 905 may be performed by a packet delay budget configuration manager 725 as described with reference to FIG. 7.

At 910, the method may include transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The operations of 910 may be performed in accordance with examples as disclosed herein. In some examples, aspects of the operations of 910 may be performed by an uplink transmission manager 730 as described with reference to FIG. 7.

At 915, the method may include ending the retransmission procedure based at least in part on an elapsed buffering time of the uplink message exceeding the packet delay budget, where ending the retransmission procedure includes skipping transmission of at least one instance of the one or more instances of the uplink message scheduled for transmission after the packet delay budget. The operations of 915 may be performed in accordance with examples as disclosed herein. In some examples, aspects of the operations of 915 may be performed by a remaining packet delay budget manager 735 as described with reference to FIG. 7.

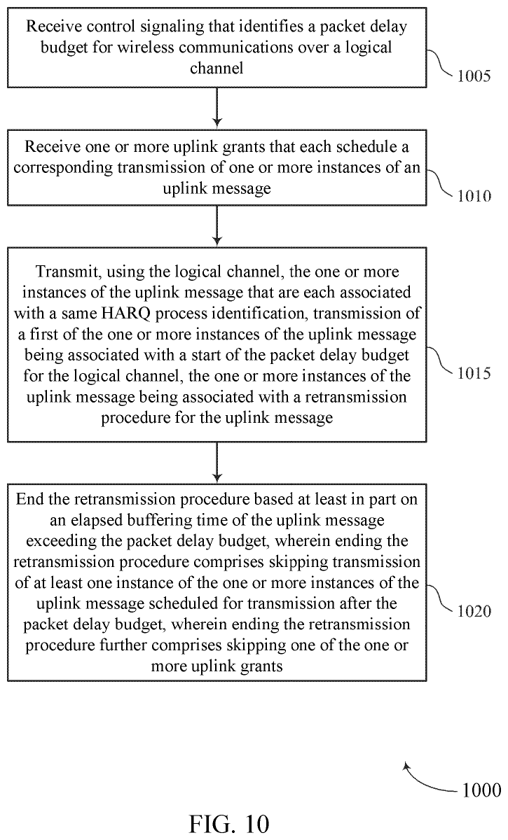

FIG. 10 shows a flowchart illustrating a method 1000 that supports deadline based hybrid automatic repeat request retransmission in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving control signaling that identifies a packet delay budget for wireless communications over a logical channel. The operations of 1005 may be performed in accordance with examples as disclosed herein. In some examples, aspects of the operations of 1005 may be performed by a packet delay budget configuration manager 725 as described with reference to FIG. 7.

At 1010, the method may include receiving one or more uplink grants that each schedule a corresponding transmission of one or more instances of an uplink message. The operations of 1010 may be performed in accordance with examples as disclosed herein. In some examples, aspects of the operations of 1010 may be performed by an uplink grant manager 740 as described with reference to FIG. 7.

At 1015, the method may include transmitting, using the logical channel, the one or more instances of the uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The operations of 1015 may be performed in accordance with examples as disclosed herein. In some examples, aspects of the operations of 1015 may be performed by an uplink transmission manager 730 as described with reference to FIG. 7.

At 1020, the method may include ending the retransmission procedure based at least in part on an elapsed buffering time of the uplink message exceeding the packet delay budget, where ending the retransmission procedure includes skipping transmission of at least one instance of the one or more instances of the uplink message scheduled for transmission after the packet delay budget, where ending the retransmission procedure further includes skipping one of the one or more uplink grants. The operations of 1020 may be performed in accordance with examples as disclosed herein. In some examples, aspects of the operations of 1020 may be performed by a remaining packet delay budget manager 735 as described with reference to FIG. 7.

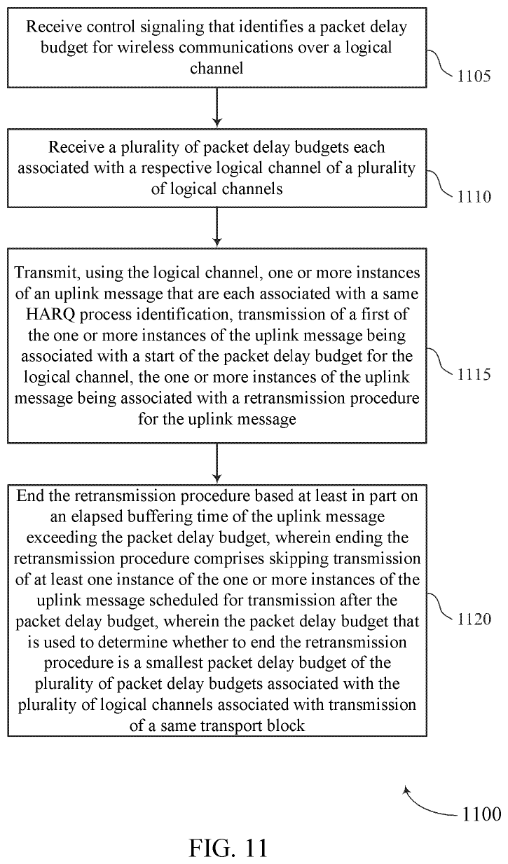

FIG. 11 shows a flowchart illustrating a method 1100 that supports deadline based hybrid automatic repeat request retransmission in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving control signaling that identifies a packet delay budget for wireless communications over a logical channel. The operations of 1105 may be performed in accordance with examples as disclosed herein. In some examples, aspects of the operations of 1105 may be performed by a packet delay budget configuration manager 725 as described with reference to FIG. 7.

At 1110, the method may include receiving a set of multiple packet delay budgets each associated with a respective logical channel of a set of multiple logical channels. The operations of 1110 may be performed in accordance with examples as disclosed herein. In some examples, aspects of the operations of 1110 may be performed by a packet delay budget configuration manager 725 as described with reference to FIG. 7.

At 1115, the method may include transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message. The operations of 1115 may be performed in accordance with examples as disclosed herein. In some examples, aspects of the operations of 1115 may be performed by an uplink transmission manager 730 as described with reference to FIG. 7.

At 1120, the method may include ending the retransmission procedure based at least in part on an elapsed buffering time of the uplink message exceeding the packet delay budget, where ending the retransmission procedure includes skipping transmission of at least one instance of the one or more instances of the uplink message scheduled for transmission after the packet delay budget, where the packet delay budget that is used to determine whether to end the retransmission procedure is a smallest packet delay budget of the set of multiple packet delay budgets associated with the set of multiple logical channels associated with transmission of a same transport block. The operations of 1120 may be performed in accordance with examples as disclosed herein. In some examples, aspects of the operations of 1120 may be performed by a remaining packet delay budget manager 735 as described with reference to FIG. 7.

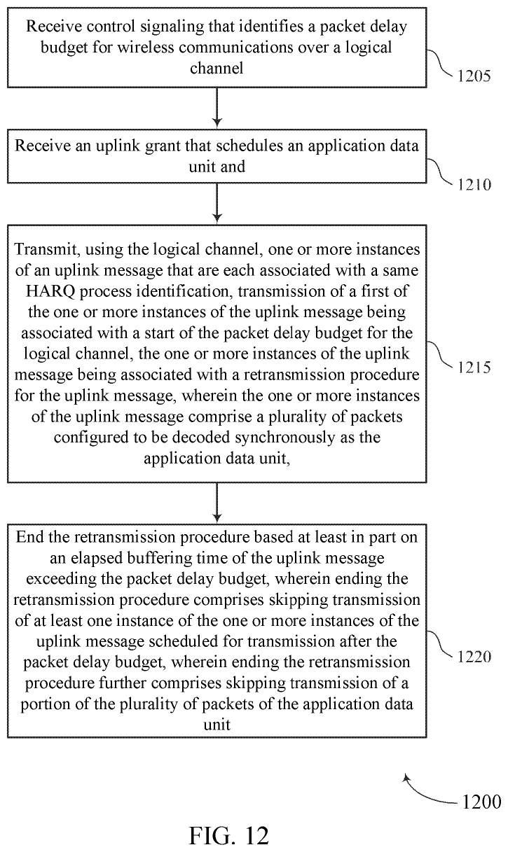

FIG. 12 shows a flowchart illustrating a method 1200 that supports deadline based hybrid automatic repeat request retransmission in accordance with one or more aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include receiving control signaling that identifies a packet delay budget for wireless communications over a logical channel. The operations of 1205 may be performed in accordance with examples as disclosed herein. In some examples, aspects of the operations of 1205 may be performed by a packet delay budget configuration manager 725 as described with reference to FIG. 7.

At 1210, the method may include receiving an uplink grant that schedules an ADU. The operations of 1210 may be performed in accordance with examples as disclosed herein. In some examples, aspects of the operations of 1210 may be performed by an ADU manager 750 as described with reference to FIG. 7.

At 1215, the method may include transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message, where the one or more instances of the uplink message include a set of multiple packets configured to be decoded synchronously as the ADU. The operations of 1215 may be performed in accordance with examples as disclosed herein. In some examples, aspects of the operations of 1215 may be performed by an uplink transmission manager 730 as described with reference to FIG. 7.

At 1220, the method may include ending the retransmission procedure based at least in part on an elapsed buffering time of the uplink message exceeding the packet delay budget, where ending the retransmission procedure includes skipping transmission of at least one instance of the one or more instances of the uplink message scheduled for transmission after the packet delay budget, where ending the retransmission procedure further includes skipping transmission of a portion of the set of multiple packets of the ADU. The operations of 1220 may be performed in accordance with examples as disclosed herein. In some examples, aspects of the operations of 1220 may be performed by a remaining packet delay budget manager 735 as described with reference to FIG. 7.

The following provides an overview of aspects of the present disclosure:

Aspect 1: A method for wireless communications at a UE, comprising: receiving control signaling that identifies a packet delay budget for wireless communications over a logical channel; transmitting, using the logical channel, one or more instances of an uplink message that are each associated with a same HARQ process identification, transmission of a first of the one or more instances of the uplink message being associated with a start of the packet delay budget for the logical channel, the one or more instances of the uplink message being associated with a retransmission procedure for the uplink message; and ending the retransmission procedure based at least in part on an elapsed buffering time of the uplink message exceeding the packet delay budget, wherein ending the retransmission procedure comprises skipping transmission of at least one instance of the one or more instances of the uplink message scheduled for transmission after the packet delay budget.

Aspect 2: The method of aspect 1, further comprising: receiving one or more uplink grants that each schedule a corresponding transmission of the one or more instances of the uplink message, wherein ending the retransmission procedure further comprises skipping one of the one or more uplink grants.

Aspect 3: The method of aspect 2, further comprising: starting a discontinuous reception retransmission timer based at least in part on receiving one of the one or more uplink grants; and stopping the discontinuous reception retransmission timer based at least in part on the elapsed buffering time of the uplink message exceeding the packet delay budget.

Aspect 4: The method of any of aspects 1 through 3, further comprising: receiving second control signaling that is indicative of a configured grant configuration for the UE, wherein the one or more instances of the uplink message are transmitted in accordance with the configured grant configuration.

Aspect 5: The method of aspect 4, further comprising: starting a configured grant timer based at least in part on transmission of the first of the one or more instances of the uplink message; and stopping the configured grant timer based at least in part on the elapsed buffering time of the uplink message exceeding the packet delay budget.

Aspect 6: The method of aspect 5, further comprising: skipping transmission of an additional instance of the one or more instances of the uplink message based at least in part on the configured grant timer being stopped.

Aspect 7: The method of any of aspects 1 through 6, wherein receiving the control signaling that identifies the packet delay budget further comprises: receiving a plurality of packet delay budgets each associated with a respective logical channel of a plurality of logical channels, wherein the packet delay budget that is used to determine whether to end the retransmission procedure is a smallest packet delay budget of the plurality of packet delay budgets associated with the plurality of logical channels associated with transmission of a same transport block.

Aspect 8: The method of any of aspects 1 through 7, further comprising: receiving an uplink grant that schedules an ADU, wherein the one or more instances of the uplink message comprise a plurality of packets configured to be decoded synchronously as the ADU, and wherein ending the retransmission procedure further comprises skipping transmission of a portion of the plurality of packets of the ADU.

Aspect 9: An apparatus for wireless communications at a UE, comprising at least one processor and memory coupled to the at least one processor, the memory storing instructions executable by the at least one processor to cause the UE to perform a method of any of aspects 1 through 8.

Aspect 10: An apparatus for wireless communications at a UE, comprising at least one means for performing a method of any of aspects 1 through 8.

Aspect 11: A non-transitory computer-readable medium storing code for wireless communications at a UE, the code comprising instructions executable by at least one processor to perform a method of any of aspects 1 through 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies including future systems and radio technologies, not explicitly mentioned herein. Components within a wireless communication system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described may be implemented in hardware, software (e.g., executed by a processor), or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
at least one processor; and
memory coupled to the at least one processor, the memory storing instructions executable by the at least one processor to cause the UE to:
receive control signaling that identifies a packet delay budget for wireless communications over a logical channel;
transmit, using the logical channel, one or more instances of an uplink message that are each associated with a same hybrid automatic repeat request (HARQ) process identification, transmission of a first of the one or more instances of the uplink message being associated with a start of the packet delay budget for the logical channel, the one or more instances of the uplink message being associated with a retransmission procedure for the uplink message; and
end the retransmission procedure based at least in part on an elapsed buffering time of the uplink message exceeding the packet delay budget, wherein ending the retransmission procedure comprises skipping transmission of at least one instance of the one or more instances of the uplink message scheduled for transmission after the packet delay budget.

2. The apparatus of claim 1, wherein the instructions are further executable by the at least one processor to cause the UE to:
receive one or more uplink grants that each schedule a corresponding transmission of the one or more instances of the uplink message, wherein ending the retransmission procedure further comprises skipping one of the one or more uplink grants.

3. The apparatus of claim 2, wherein the instructions are further executable by the at least one processor to cause the UE to:
start a discontinuous reception retransmission timer based at least in part on receiving one of the one or more uplink grants; and
stop the discontinuous reception retransmission timer based at least in part on the elapsed buffering time of the uplink message exceeding the packet delay budget.

4. The apparatus of claim 1, wherein the instructions are further executable by the at least one processor to cause the UE to:
receive second control signaling that is indicative of a configured grant configuration for the UE, wherein the one or more instances of the uplink message are transmitted in accordance with the configured grant configuration.

5. The apparatus of claim 4, wherein the instructions are further executable by the at least one processor to cause the UE to:
start a configured grant timer based at least in part on transmission of the first of the one or more instances of the uplink message; and
stop the configured grant timer based at least in part on the elapsed buffering time of the uplink message exceeding the packet delay budget.

6. The apparatus of claim 5, wherein the instructions are further executable by the at least one processor to cause the UE to:
skip transmission of an additional instance of the one or more instances of the uplink message based at least in part on the configured grant timer being stopped.

7. The apparatus of claim 1, wherein the instructions to receive the control signaling that identifies the packet delay budget are further executable by the at least one processor to cause the UE to:
receive a plurality of packet delay budgets each associated with a respective logical channel of a plurality of logical channels, wherein the packet delay budget that is used to determine whether to end the retransmission procedure is a smallest packet delay budget of the plurality of packet delay budgets associated with the plurality of logical channels associated with transmission of a same transport block.

8. The apparatus of claim 1, wherein the instructions are further executable by the at least one processor to cause the UE to:
receive an uplink grant that schedules an application data unit, wherein the one or more instances of the uplink message comprise a plurality of packets configured to be decoded synchronously as the application data unit, and wherein ending the retransmission procedure further comprises skipping transmission of a portion of the plurality of packets of the application data unit.

9. A method for wireless communications at a user equipment (UE), comprising:
receiving control signaling that identifies a packet delay budget for wireless communications over a logical channel;
transmitting, using the logical channel, one or more instances of an uplink message that are each associated with a same hybrid automatic repeat request (HARQ) process identification, transmission of a first of the one or more instances of the uplink message being associated with a start of the packet delay budget for the logical channel, the one or more instances of the uplink message being associated with a retransmission procedure for the uplink message; and
ending the retransmission procedure based at least in part on an elapsed buffering time of the uplink message exceeding the packet delay budget, wherein ending the retransmission procedure comprises skipping transmission of at least one instance of the one or more instances of the uplink message scheduled for transmission after the packet delay budget.

10. The method of claim 9, further comprising:
receiving one or more uplink grants that each schedule a corresponding transmission of the one or more instances of the uplink message, wherein ending the retransmission procedure further comprises skipping one of the one or more uplink grants.

11. The method of claim 10, further comprising:
starting a discontinuous reception retransmission timer based at least in part on receiving one of the one or more uplink grants; and
stopping the discontinuous reception retransmission timer based at least in part on the elapsed buffering time of the uplink message exceeding the packet delay budget.

12. The method of claim 9, further comprising:
receiving second control signaling that is indicative of a configured grant configuration for the UE, wherein the one or more instances of the uplink message are transmitted in accordance with the configured grant configuration.

13. The method of claim 12, further comprising:
starting a configured grant timer based at least in part on transmission of the first of the one or more instances of the uplink message; and
stopping the configured grant timer based at least in part on the elapsed buffering time of the uplink message exceeding the packet delay budget.

14. The method of claim 13, further comprising:
skipping transmission of an additional instance of the one or more instances of the uplink message based at least in part on the configured grant timer being stopped.

15. The method of claim 9, wherein receiving the control signaling that identifies the packet delay budget further comprises:
receiving a plurality of packet delay budgets each associated with a respective logical channel of a plurality of logical channels, wherein the packet delay budget that is used to determine whether to end the retransmission procedure is a smallest packet delay budget of the plurality of packet delay budgets associated with the plurality of logical channels associated with transmission of a same transport block.

16. The method of claim 9, further comprising:
receiving an uplink grant that schedules an application data unit, wherein the one or more instances of the uplink message comprise a plurality of packets configured to be decoded synchronously as the application data unit, and wherein ending the retransmission procedure further comprises skipping transmission of a portion of the plurality of packets of the application data unit.

17. An apparatus for wireless communications at a user equipment (UE), comprising:
means for receiving control signaling that identifies a packet delay budget for wireless communications over a logical channel;
means for transmitting, using the logical channel, one or more instances of an uplink message that are each associated with a same hybrid automatic repeat request (HARQ) process identification, transmission of a first of the one or more instances of the uplink message being associated with a start of the packet delay budget for the logical channel, the one or more instances of the uplink message being associated with a retransmission procedure for the uplink message; and
means for ending the retransmission procedure based at least in part on an elapsed buffering time of the uplink message exceeding the packet delay budget, wherein ending the retransmission procedure comprises skipping transmission of at least one instance of the one or more instances of the uplink message scheduled for transmission after the packet delay budget.

18. The apparatus of claim 17, further comprising:
means for receiving one or more uplink grants that each schedule a corresponding transmission of the one or more instances of the uplink message, wherein ending the retransmission procedure further comprises skipping one of the one or more uplink grants.

19. The apparatus of claim 18, further comprising:
means for starting a discontinuous reception retransmission timer based at least in part on receiving one of the one or more uplink grants; and
means for stopping the discontinuous reception retransmission timer based at least in part on the elapsed buffering time of the uplink message exceeding the packet delay budget.

20. The apparatus of claim 17, further comprising:
means for receiving second control signaling that is indicative of a configured grant configuration for the UE, wherein the one or more instances of the uplink message are transmitted in accordance with the configured grant configuration.

21. The apparatus of claim 20, further comprising:
means for starting a configured grant timer based at least in part on transmission of the first of the one or more instances of the uplink message; and
means for stopping the configured grant timer based at least in part on the elapsed buffering time of the uplink message exceeding the packet delay budget.

22. The apparatus of claim 21, further comprising:
means for skipping transmission of an additional instance of the one or more instances of the uplink message based at least in part on the configured grant timer being stopped.

23. The apparatus of claim 17, wherein the means for receiving the control signaling that identifies the packet delay budget further comprise:
means for receiving a plurality of packet delay budgets each associated with a respective logical channel of a plurality of logical channels, wherein the packet delay budget that is used to determine whether to end the retransmission procedure is a smallest packet delay budget of the plurality of packet delay budgets associated with the plurality of logical channels associated with transmission of a same transport block.

24. The apparatus of claim 17, further comprising:
means for receiving an uplink grant that schedules an application data unit, wherein the one or more instances of the uplink message comprise a plurality of packets configured to be decoded synchronously as the application data unit, and wherein ending the retransmission procedure further comprises skipping transmission of a portion of the plurality of packets of the application data unit.

25. A non-transitory computer-readable medium storing code for wireless communications at a user equipment (UE), the code comprising instructions executable by at least one processor to:
receive control signaling that identifies a packet delay budget for wireless communications over a logical channel;
transmit, using the logical channel, one or more instances of an uplink message that are each associated with a same hybrid automatic repeat request (HARQ) process identification, transmission of a first of the one or more instances of the uplink message being associated with a start of the packet delay budget for the logical channel, the one or more instances of the uplink message being associated with a retransmission procedure for the uplink message; and
end the retransmission procedure based at least in part on an elapsed buffering time of the uplink message exceeding the packet delay budget, wherein ending the retransmission procedure comprises skipping transmission of at least one instance of the one or more instances of the uplink message scheduled for transmission after the packet delay budget.

26. The non-transitory computer-readable medium of claim 25, wherein the instructions are further executable by the at least one processor to:
receive one or more uplink grants that each schedule a corresponding transmission of the one or more instances of the uplink message, wherein ending the retransmission procedure further comprises skipping one of the one or more uplink grants.

27. The non-transitory computer-readable medium of claim 26, wherein the instructions are further executable by the at least one processor to:
start a discontinuous reception retransmission timer based at least in part on receiving one of the one or more uplink grants; and
stop the discontinuous reception retransmission timer based at least in part on the elapsed buffering time of the uplink message exceeding the packet delay budget.

28. The non-transitory computer-readable medium of claim 25, wherein the instructions are further executable by the at least one processor to:
receive second control signaling that is indicative of a configured grant configuration for the UE, wherein the one or more instances of the uplink message are transmitted in accordance with the configured grant configuration.

29. The non-transitory computer-readable medium of claim 28, wherein the instructions are further executable by the at least one processor to:
start a configured grant timer based at least in part on transmission of the first of the one or more instances of the uplink message; and
stop the configured grant timer based at least in part on the elapsed buffering time of the uplink message exceeding the packet delay budget.

30. The non-transitory computer-readable medium of claim 29, wherein the instructions are further executable by the at least one processor to:
skip transmission of an additional instance of the one or more instances of the uplink message based at least in part on the configured grant timer being stopped.
